(19) United States
(12) Patent Application Publication
(10) Pub. No.: US 2011/0248667 A1
(43) Pub. Date: Oct. 13, 2011

(54) VEHICLE

(75) Inventor: Hidetaka UMEOKA, Niiza-shi (JP)

(73) Assignee: HONDA ACCESS CORP., Niiza-shi (JP)

(21) Appl. No.: 13/039,844

(22) Filed: Mar. 3, 2011

(30) Foreign Application Priority Data
Mar. 3, 2010 (JP) 2010-047066

(51) Int. Cl. H01M 10/46

(52) U.S. Cl. 320/101

(57) ABSTRACT

A battery capable of being charged by a solar cell and an electric generator has its state of charge detected by a charge-state detecting sensor, and an electric generator operation control device controls the charge of the battery by the electric generator in accordance with the detection result detected by the charge-state detecting sensor so as to make the state of charge detected by the charge-state detecting sensor less than 100%. Accordingly, it is possible to effectively charge the battery by electricity obtained by the solar cell.

### TECHNICAL FIELD

The present invention relates to a vehicle in which a battery is charged by electricity generated by a solar cell.

### BACKGROUND OF THE INVENTION

Japanese Patent No. 3094366 has made publicly known a configuration in which a battery installed in a vehicle is charged by electricity obtained by solar cells attached on a substantially entire surface of a vehicle body cover covering an entire vehicle.

Meanwhile, a battery is constantly fully-charged by electricity generated by an electric generator. For this reason, in a case in which the battery is fully-charged, even if the battery is to be charged by electricity obtained by solar cells during parking as disclosed in Japanese Patent No. 3094366, the electricity thus generated by the solar cells can not be charged effectively to the battery.

### SUMMARY OF THE INVENTION

The present invention has been made in view of the foregoing situation. As such, a vehicle can effectively charge a battery by electricity obtained from a solar cell.

Accordingly, in a vehicle in which a prime mover has an electric generator capable of charging a battery, the vehicle includes a solar cell capable of charging the battery, a charge-state detecting sensor for detecting a state of charge of the battery, and electric generator operation control means for controlling charge of the battery by the electric generator in accordance with a detection result detected by the charge-state detecting sensor so as to make the state of charge detected by the charge-state detecting sensor less than 100%.

As disclosed herein, an engine corresponds to a motor or prime mover, and a State of Charge sensor (SOC sensor) corresponds to a charge-state detecting sensor.

Accordingly, when the state of charge of the battery is less than 100%, it is possible to charge the battery effectively when the battery is to be charged by electricity obtained by the solar cell.

The above features and advantages will be clear from detailed descriptions provided below, while referring to the attached drawings.

### BRIEF DESCRIPTION OF THE DRAWINGS

FIG. 1 is a perspective view of a vehicle and a solar cell panel;

FIG. 2 is a block diagram showing an electric system related to a battery and the solar cell; and

FIG. 3 is a view showing a change in the charge state of the battery through passage of time.

### DETAILED DESCRIPTION OF THE INVENTION

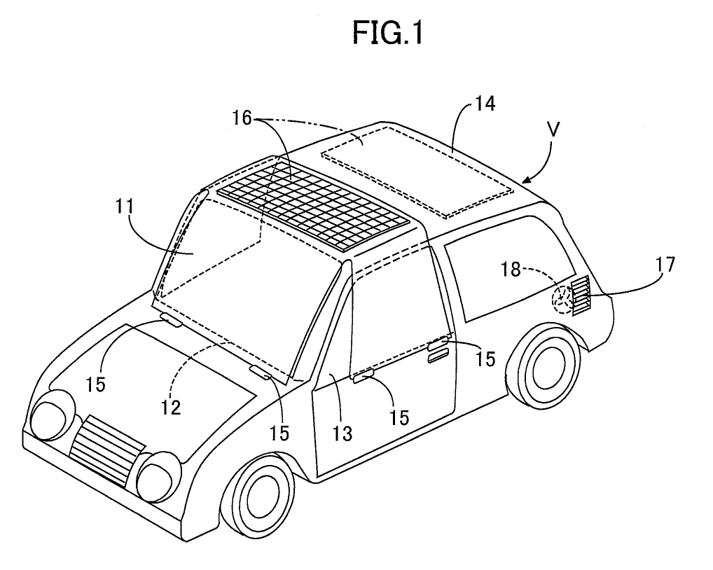

Detailed descriptions of the present invention are set forth below while referring to FIGS. 1 to 3. At first, in FIG. 1, at least a part of an outer surface of a vehicle V is covered by a cover 11 having a flexibility and covering at least a front windshield 12 during parking in a hot season. In the present embodiment, cover 11 is formed to cover not only front windshield 12 of the vehicle V but also right and left front-side windows 13 of the vehicle V as well as a front part of a roof 14 of the vehicle V. A plurality of attaching hooks 15 attached to peripheral edge portions of cover 11 with spacing therebetween are engaged detachably with the body of the vehicle V, so that cover 11 may be attached to the vehicle V.

Further, a solar cell panel 16 is mounted on at least a portion of cover 11 which is disposed on the roof 14 of the vehicle V. As illustrated in FIG. 1, solar cell panel 16, which is illustrated by solid line, is mounted only on a portion of cover 11 which is disposed on roof 14 of the vehicle V. In an outer surface of a rear part of the vehicle V, an air-discharge port 17 for discharging air inside a vehicle compartment is provided such that water and the like from the outside may not enter into the vehicle compartment side through the port. A fan 18 capable of discharging air inside the vehicle compartment to the outside is disposed at a position inside air-discharge port 17 in the vehicle V.

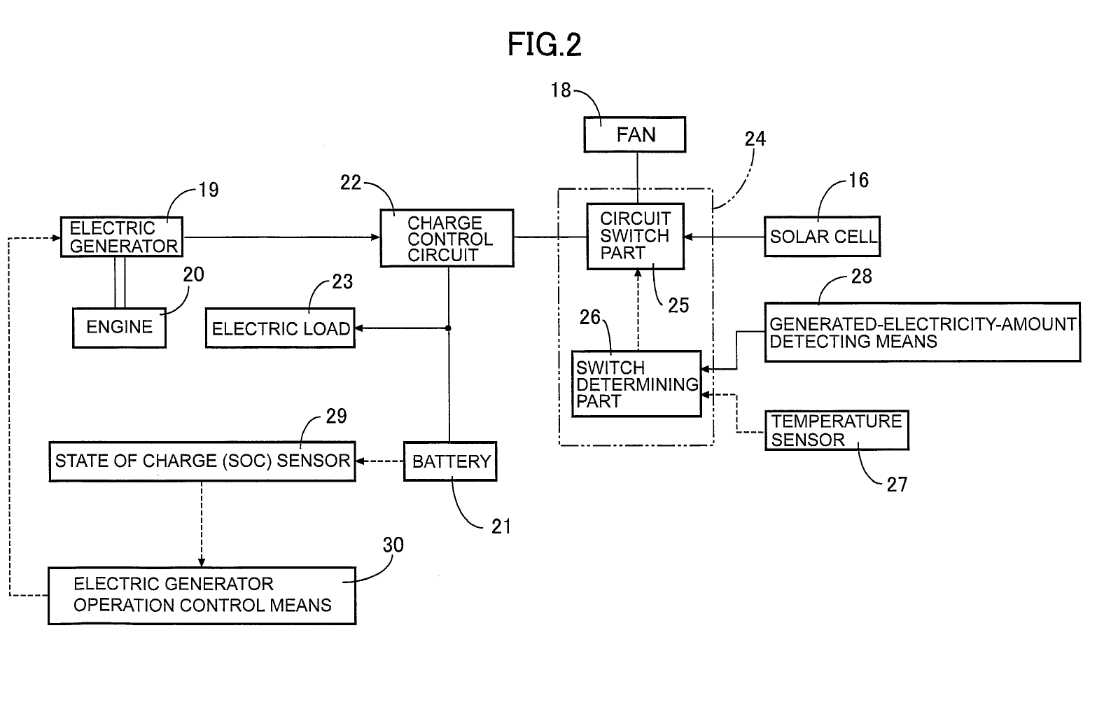

The block diagram of FIG. 2, shows an engine 20 coupled with an electric generator 19 in the vehicle V so as to transmit power to driven wheels, for example, right and left front wheels. Further, vehicle V also includes a battery 21 capable of being charged by electric generator 19.

Electric generator 19 is connected to battery 21 via a charge control circuit 22 for controlling a charge of electricity generated by the electric generator 19 and transmitted to battery 21, and a variety of electric loads 23 provided in the vehicle V are also connected to battery 21. On the other hand, the solar cell panel 16 mounted on the cover 11 is connected to supply-point switch control means 24 disposed in the vehicle compartment via an electric wire inserted through, for example, an interspace between a door and the vehicle body.

Supply-point switch control means 24 includes a circuit switch part 25 switching between the state in which electricity generated by the solar cell panel 16 is supplied to fan 18 and the state in which the electricity is used to charge battery 21 via charge control circuit 22, and a switch determining part 26 determining which state circuit switch part 25 is to be. At least one of a detected value of a temperature sensor 27, detecting a temperature inside the vehicle compartment, and a detected value of generated-electricity-amount, detecting means 28 detecting an amount of electricity generated by solar cell panel 16, is inputted to switch determining part 26. In the present embodiment, both of the detected value of temperature sensor 27 and the detected value of the generated-electricity-amount detecting means 28 are inputted to switch determining part 26. If the detected value of the temperature sensor 27 is lower than a predetermined temperature which is set so as to become lower as the detected value of generated-electricity-amount detecting means 28 becomes larger, switch determining part 26 switches circuit switch part 25 to the state in which the electricity generated by solar cell panel 16 is used to charge battery 21. If the detected value of temperature sensor 27 is higher than the predetermined temperature, switch determining part 26 switches circuit switch part 25 to the state in which fan 18 is driven to discharge air inside the vehicle compartment to the outside.

A State of Charge (hereinafter, called “SOC”) sensor 29, which is a charge-state detecting sensor, for detecting the SOC of the battery 21 is coupled with battery 21. By electric generator operation control means 30 controlling an operation of the electric generator 19 based on a detected value of the SOC sensor 29, the charging of battery 21 by the electric generator 19 is controlled.

The electric generator operation control means 30 controls the charging of battery 21 by electric generator 19 by performing a refresh charge in such a way that, when SOC detected by SOC sensor 29 becomes equal to or lower than a first predetermined value S1 (for example, SOC: 64%), the charging by electric generator 19 is started, whereas when the SOC reaches a value larger than the first predetermined value S1 but lower than a value of the full-charged state, that is, a second predetermined value S2 set as a value lower than 100% (for example, SOC: 90%), the charging by the electric generator 19 is stopped.

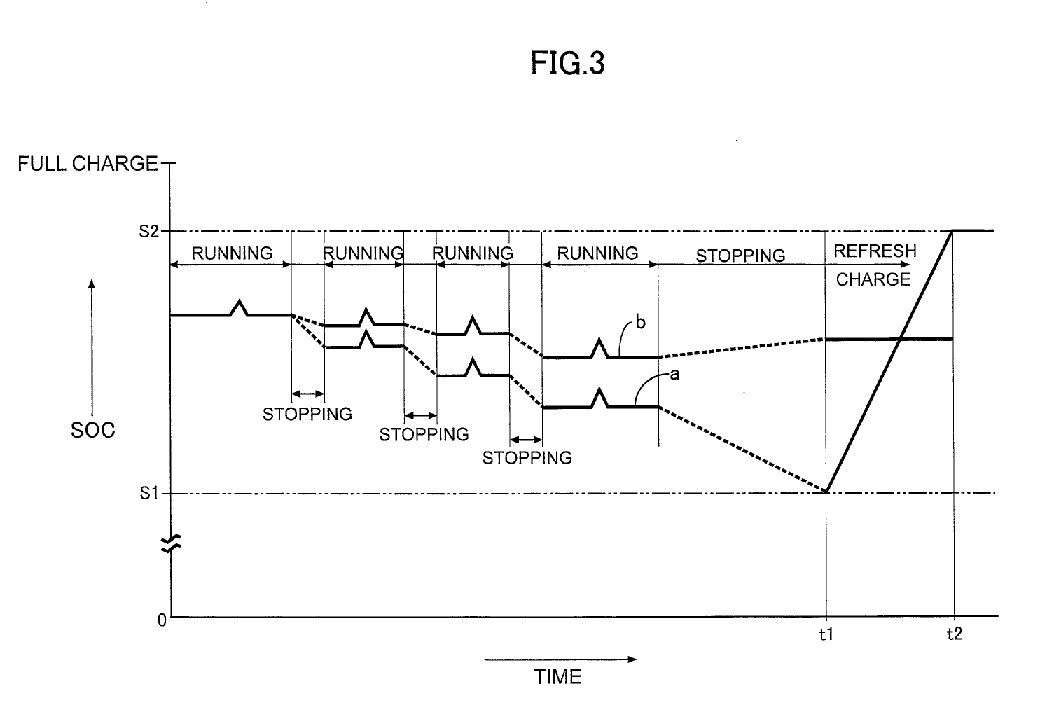

To put it specifically, in the case where there is no charge from solar cell panel 16, as shown in a line a in FIG. 3, a charge state of battery 21 is fluctuated to some extent in an up-and-down manner due to discharge/regeneration when the vehicle is travelling, and the charge state of battery 21 drops due to dark-current discharge when the vehicle stops. At time t1 when the SOC of battery 21 becomes equal to or lower than the first predetermined value S1, electric generator 19 starts to charge battery 21, and at time t2 when SOC reaches the second predetermined value S2, electric generator 19 stops charging battery 21. Accordingly, the SOC of battery 21 is changed between the first predetermined value S1 and the second predetermined value S2. On the other hand, according to this embodiment, as shown in a line b in FIG. 3, when the vehicle stops, the SOC is suppressed from dropping or is raised by electric generation of solar cell panel 16, thereby it is possible to effectively charge battery 21 by the electricity obtained by solar cell panel 16.

Next, the operation of the present embodiment will be explained. Since the cover 11 covers at least front windshield 12, it is possible to suppress the incidence of sunlight into the vehicle compartment when the vehicle is parked outside in a hot season. Furthermore, fan 18 is caused to be operated by the supply of electricity obtained by electric generation of solar cell panel 16 mounted on cover 11, and air inside the vehicle compartment is thus discharged to the outside. Accordingly, it is possible to avoid the inside of the vehicle compartment from being hot, so that when a passenger rides on the vehicle, he/she does not feel uncomfortable due to the temperature inside the vehicle compartment becoming high, which may otherwise occur. Moreover, the charge state of battery 21 is not deteriorated due to the operation of fan 18.

Further, when the temperature inside the vehicle compartment is lower than the predetermined temperature, which is set so as to become lower as the amount of generated electricity becomes larger, that is, when the amount of solar radiation is small, battery 21 is charged by electricity generated by solar cell panel 16. Accordingly, it is possible to reduce the charging load of battery 21 by electric generator 19 driven by engine 20 installed in the vehicle V and thus to reduce consumption energy of engine 20.

Further, since solar cell panel 16 is mounted on at least that portion of cover 11 disposed on roof 14 of the vehicle V, it is possible to generate electricity at least by solar cell panel 16 disposed on roof 14 of the vehicle V, regardless of the direction of the vehicle V during parking.

Further, refresh charging is performed in such a way that when the SOC of battery 21 detected by SOC sensor 29 becomes equal to or lower than the first predetermined value S1, charging by the electric generator 19 is started, whereas when the SOC reaches the value larger than the first predetermined value S1 but lower than the value of the full-charged state, that is, the second predetermined value S2 set as the value lower than 100%, the charge by electric generator 19 is stopped. Accordingly, when the battery 21 is charged by solar cell panel 16, battery 21 is not in the full-charged state. For this reason, it is possible to charge battery 21 effectively by solar cell panel 16.

It may be configured, as another embodiment of the present invention, to switch between the state in which electricity is supplied from solar cell panel 16 to heaters provided on a steering wheel and a vehicle seat inside the vehicle compartment and the state in which electricity from solar cell panel 16 charges battery 21, in accordance with a detected value of temperature sensor 27. This configuration enables cover 11 to prevent the front windshield 12 from being frosted; and electricity obtained by electric generation of solar cell panel 16 attached to cover 11 is to be supplied to heat at least one of the steering wheel and the vehicle seat by the associated heater. Accordingly, it is possible to relieve a passenger from feeling discomfort even if the temperature inside the vehicle compartment is low at the time of riding in the vehicle, because the steering wheel or the vehicle seat has become warm.

It may also be configured to operate fan 18 in a hot season and to heat by use of the heater in a cold season.

For example, as described above, solar cell panel 16 is mounted on cover 11, but the present invention may also be applied to the case in which solar cell panel 16 is fixedly mounted on roof 14 and the like of the vehicle V, independently of cover 11. Solar cell panel 16 which is illustrated by solid line shows the state in which solar cell panel is mounted only on a portion of cover 11. Solar cell panel 16 which is illustrated by break line shows the state in which solar cell panel is fixedly mounted on roof 14.

Although a specific form of embodiment of the instant invention has been described above and illustrated in the accompanying drawings in order to be more clearly understood, the above description is made by way of example and not as a limitation to the scope of the instant invention. It is contemplated that various modifications apparent to one of ordinary skill in the art could be made without departing from the scope of the invention which is to be determined by the following claims.

I claim:

1. A vehicle having a prime mover, a battery, and an electric generator driven by the prime mover and capable of charging the battery, said vehicle comprising:
a solar cell capable of charging the battery;
a charge-state detecting sensor for detecting a state of charge of the battery; and
electric generator operation control means for controlling the state of charge of the battery by the electric generator in accordance with a detection result detected by said charge-state detecting sensor so as to make the state of charge, detected by said charge-state detecting sensor, less than 100%.

2. The vehicle of claim 1, wherein said solar cell is attached to a cover covering at least a portion of the vehicle.

3. The vehicle of claim 1, wherein said solar cell is attached to said vehicle.
